(19) United States
(12) Patent Application Publication
(10) Pub. No.: US 2003/0202104 A1
(43) Pub. Date: Oct. 30, 2003

(54) Location-based services for photography

(76) Inventor: Raymond J. Werner, Portland, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 09/902,866

(22) Filed: Jul. 10, 2001

(51) Int. Cl. H04N 5/225

(52) U.S. Cl. 348/207.99

(57) ABSTRACT

A location-based service provides for reception of information that defines the location of a location-aware image capture device, such as, for example, a camera. The location-based service provides for transmission to the location-aware image capture device, or a user thereof, information regarding at least the location of a photo processing establishment. In one embodiment, a list of photo processing establishments is provided, wherein the list is of those establishments that meet pre-determined requirements. In another embodiment, the location-based service provides for reception of image data from the location-aware image capture device. In still another embodiment, the location-based service can transmit the image data to one or more photo processing establishment, and may further transmit instructions as to how to process the image data.

### FIELD OF THE INVENTION

The methods and apparatus of the present invention relate generally to the field of location-based services, and more particularly to providing services in connection with photography.

### BACKGROUND

The deployment in modern times of communication satellites in Earth orbit, such as those which form the well-known Global Positioning System (GPS), have enabled, first, military systems, and subsequently, commercial systems to use signals from orbiting satellites to determine their location on earth. In this way, the navigation of military and commercial vehicles by automatic guidance systems has been facilitated.

In addition to guidance system applications, signals from the Global Positioning System have been used in conjunction with various hardware and software products for providing terrestrial coordinates to users such as hikers or backpackers who want or need to know their locations. Similarly, fleets of trucks have been equipped with GPS systems so that their location can be determined.

As the application and acceptance of GPS-based location systems has grown, the cost of such GPS hardware and software has begun to decline. With declining prices, it is anticipated that the deployment of such location information resources in a wide variety of electronic products will become feasible.

One desirable application of location information in connection with photographic systems is location stamping. That is, having the ability to label image data, or a photographic image, with information that indicates where the image data was actually captured. The use of GPS systems, or subsystems, in combination with photographic equipment to record contemporaneous image data and geographical location information have been described in U.S. Pat. No. 5,506,644 to Suzuki, et al., and U.S. Pat. No. 5,671,451 to Takahashi, et al.

However, with the more recent wide-spread deployment of wireless communication systems, it is possible to provide location-based services to remote devices that are location-aware.

What is needed are methods and apparatus for advantageously utilizing the previously described combination of GPS systems, or subsystems, and photographic equipment, so as to provide desirable location-based services for such equipment and the users of such equipment.

### SUMMARY OF THE INVENTION

Briefly, a location-based service provides for reception of information that defines the location of a location-aware image capture device, such as, for example, a camera. The location-based service provides for transmission to the location-aware image capture device, or a user thereof, information regarding at least the location of a photo processing establishment.

In a further aspect of the present invention, the location-based service provides for reception of image data from the location-aware image capture device.

In a still further aspect of the present invention, the location-based service can transmit the image data to at least one photo processing establishment.

### BRIEF DESCRIPTION OF THE DRAWINGS

FIG. 1 is a block diagram representation of a camera in conjunction with a location-aware product equipped with a GPS module that provides location information to the product in accordance with the present invention.

FIG. 2 is a block diagram of a service center that provides location-based services, the service center including a computer system, a database of customer specified geographical boundaries that define particular geographical regions, a database of geographical regions known to have radio transmission or reception problems, and a network interface; and further shows a network communications cloud, and an illustrative computer interfaced to the service center through the communications cloud.

FIG. 3 is a flowchart of an illustrative process in accordance with the present invention that receives location information from a location-aware device relative to the position of the location-aware device, and transmits location information to the location-aware device relative to the position of one or more photo processing establishments.

FIG. 4 is a flowchart of an illustrative process, in accordance with the present invention, that receives location information from a location-aware device relative to the position of the location-aware device, transmits location information to the location-aware device relative to the position of one or more photo processing establishments, and further transmits information to the location-aware device regarding communication of image data to at least one photo processing establishment.

FIG. 5 is a flowchart of an illustrative process, in accordance with the present invention, that that receives location information from a location-aware device relative to the position of the location-aware device, transmits location information to the location-aware device relative to the position of one or more photo processing establishments, receives information from the location-aware device relative to the selection of one or more photo processing establishments, receives image data from the location-aware product, and further transmits image data to the one or more selected photo processing establishments.

FIG. 5 is a flowchart of an illustrative process, in accordance with the present invention, that that receives location information from a location-aware device relative to the position of the location-aware device, transmits location information to the location-aware device relative to the position of one or more photo processing establishments, receives information from the location-aware device relative to the selection of one or more photo processing establishments, receives additional instructions from the location-aware device, receives image data from the location-aware product, and further transmits image data to the one or more selected photo processing establishments

FIG. 7 is a flowchart of an illustrative process, in accordance with the present invention, that transmits location information from a location-aware device to a location-based services provider, and receives location data relative to the location of one or more photo processing establishments.

FIG. 8. is a flowchart of an illustrative process, in accordance with the present invention, that transmits location information from a location-aware device to a location-based services provider, receives information regarding a physical and/or communication address of at least one photo processing establishment, and transmits image data to at least one photo processing establishment.

FIG. 9 is a flowchart of an illustrative process, in accordance with the present invention, that receives image data from a location-based services provider, receives customer identification information from a location-based services provider, and produces one or more photo prints.

FIG. 10 is a flowchart of an illustrative process, in accordance with the present invention, that receives image data from a location-based services provider, receives customer identification information from a location-based services provider, produces one or more photo prints, and transmits status to the location-aware product.

FIG. 11 is a flowchart of an exemplary process, showing various aspects of embodiments of the present invention.

FIG. 12 is a flowchart of an exemplary process, showing various aspects of embodiments of the present invention.

### DETAILED DESCRIPTION

Overview

It is often the case that people take pictures or videos and wish to have hardcopies, that is, prints, made of the images they have captured. It is also often the case that people wish to have prints made quickly, and so search for photo processing establishments that can provide such services in a short time. It is also the case that people wish to have prints available in more than one location quickly.

In view of the foregoing, embodiments of the present invention provide advantages wherein prints can be made quickly and conveniently, even when a photographer is in an unfamiliar location.

Generally, embodiments of the present invention include an image capture device that is integrated with, or that can be communicatively coupled to a location information resource such as a GPS module; and that is further integrated with, or that can be communicatively coupled to, a wireless communication module capable of transmitting information from the image capture device to a location-based services provider that is remote from the image capture device. The location-based service provider.

An illustrative embodiment of the present invention includes a digital camera equipped with a GPS module and a cellular telephone communications module. The camera can communicate with a remote location-based services provider, identifying itself, its location, and the nature of its service request. The location-based service provider, in this example, responds to the camera with information regarding the location of one or more photo processing establishments.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

Terminology

The expression “location information resource” is intended to mean any type of hardware or hardware/software combination that provides location, that is, positional, information to a device. By way of example, and not limitation, a location information resource may be implemented as a GPS module. As is well known, GPS modules receive signals from a plurality of earth-orbiting satellites and process those signals, by computation or otherwise, to determine from those signals the position of the GPS module. Those skilled in the art will recognize that many variations are possible, such as, for example and not limitation, receiving signals from satellites and earth-based transmitters to determine location.

The expression “location-aware product” is intended to mean any type of product that is able to at least receive, compute, determine, establish, ascertain, perceive, or otherwise be aware of its location, in one or more position defining formats or media. A location-aware product, as used herein, does not necessarily need to know its position to any particular degree of accuracy, although it is preferable that embodiments are able to know their location to within approximately 100 meters of their true position, or better. Additionally, although any position defining format may be used within the scope of the present invention, typical embodiments described below use latitude and longitude to described geographical locations on Earth.

The expression “image capture device” is intended to mean any type of image capture instrument or device, such as, for example still picture cameras using conventional film, still picture cameras using any form of electronic storage of image data, moving picture cameras, video cameras or camcorders, and using any type of image sensor whether optical lens and film combination, or Charge Coupled Device (CCD) image sensors, Complementary Metal Oxide Semiconductor (CMOS) image sensors, photo diodes (individually or in any form of array), and so on, whether the image captured is in the visible portion of the electromagnetic spectrum or outside of the visible portion of the electromagnetic spectrum. It is also intended that the “image capture device” include any means of capturing an image such as, for example, an image created with a personal digital assistant, personal computer, or other type of computational device that is operable to create and/or edit image data.

The expression “location-aware image capture device” is intended to mean any type of image capture device that has integrated therewith, or is operable to be communicatively coupled to, a location information resource. Unless otherwise noted herein, it is intended that location-aware image capture devices include wireless communication capability, regardless of whether that functionality is integrated into the image capture device, the location information resource, or another module that is communicatively coupled to the location-aware image capture device.

The expression “photo processing establishment” is intended to mean any type of facility that can, at least, receive information, and based, at least in part, on that information, create, produce, print, or otherwise form one or more humanly perceivable copies of images representative of the information received.

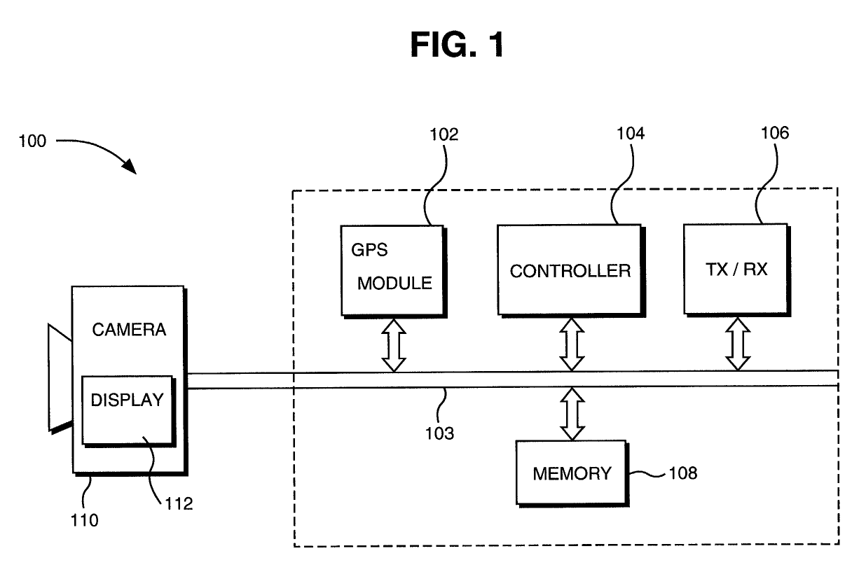

FIG. 1 is a block diagram representation of a location-aware image capture device 100 equipped with a location information resource, such as a GPS module, that provides location information to location-aware image capture device 100. More particularly, a GPS module 102 is shown coupled to a controller 104 by way of bus 103. GPS modules are commercially available from a number of manufacturers. An antenna suitable for receiving GPS signals is typically included within GPS module 102, but such antenna may be spaced apart from location-aware module 102. If the antenna is spaced apart from GPS module 102, then the antenna is appropriately coupled to GPS module 102. In the illustrated embodiment, GPS module 102 includes a GPS receiver and processing circuitry to convert the received GPS signals into location coordinates, such as, but not limited to, latitude and longitude. Bus 103 may be any suitable means of providing communication between GPS module 102 and controller 104. For example, bus 103 may be, but is not limited to being, a direct, wired connection to Input/Output (I/O) ports of controller 104, or a shared bus connection to controller 104. Controller 104 is typically an integrated circuit referred to in the field as an embedded microprocessor. Alternatively, it may be a microcontroller, and microprocessor, an application specific integrated circuit (ASIC), or any other type of processor generally capable of executing a stored program. Controller 104 is coupled to a transmitter/receiver (TX/RX) 106 by way of bus 103. TX/RX 106 may be any radio circuitry capable of receiving signals representative of commands from a remote site and transmitting location information to a remote site. Typically, TX/RX 106 is similar, or identical to the radio portion of a cellular telephone. Various cellular telephone protocols and radio frequencies may be used in connection with the present invention. That is, the present invention is not limited to any particular protocol or frequency. Location-aware image capture device 100, having a cellular phone mechanism incorporated therein for communication with the service center typically requires that a particular cellular communications service provider be engaged to provide “airtime”.

Still referring to FIG. 1, controller 104 is also coupled to a memory 108, by way of a bus 103. Memory 108 may be any suitable memory for use with controller 104, such as, but not limited to, static RAM, dynamic RAM, flash, ROM, or various combinations of the aforementioned memories.

Continuing to refer to FIG. 1, it should be noted that reading location information from GPS module 102 is similar to reading information from any commonly available type of computer peripheral device. For example, one or more fixed addresses in a memory, or I/O space, may be read and the resulting data represents the location information. In an alternative embodiment, a command is written to GPS module 102 and as a consequence, location information is transferred by GPS module 102 to some pre-determined address. Those skilled in the art will appreciate that a variety of communication pathways and methods to transfer information between a peripheral device such as GPS module 102, and controller 104, are well known and understood in this field.

Still referring to FIG. 1, a camera unit 110 is coupled to bus 103. Camera unit 110 includes a display 112, which is typically implemented as a liquid crystal display. In this illustrative embodiment, camera unit 110 is a digital camera that is operable to image a scene, or target, and to record that captured image in electronic format. Camera 110, further includes an electronic interface to bus 103 such that image data may be transferred from camera to memory 108 and/or to TX/RX 106. Similarly, information may be transferred to display 112 by way of bus 103.

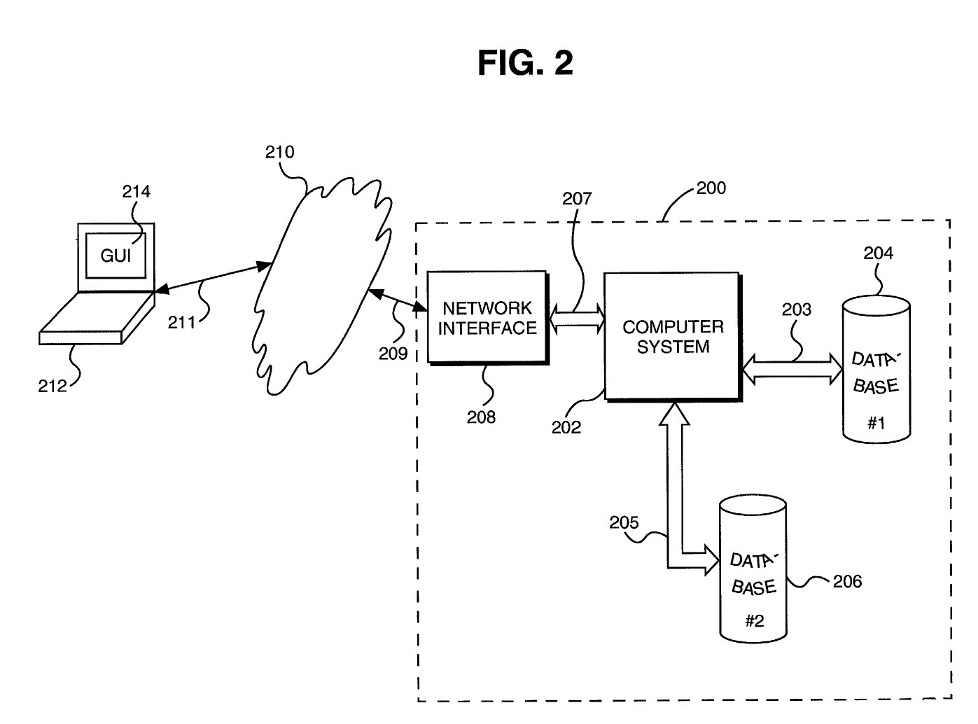

FIG. 2 is a block diagram of a service center, in accordance with the present invention, that provides location-based services, the service center including a computer system, a database of customer specified geographical boundaries that define particular geographical regions, a database of geographical regions known to have radio transmission or reception problems, and a network interface; and further shows a network communications cloud, and an illustrative computer interfaced to the service center through the communications cloud. More particularly, illustrative service center 200 includes a computer system 202 coupled to a first database 204 by means of communication pathway 203. The information contained in database 204 is typically stored on one or more hard disk drives, but any suitable memory storage medium can be used. Database 204 may be flat, relational, or conform to any other database architecture. Database 204 as used in this illustrative embodiment of the present invention, contains information in connection with various regions in which radio performance issues may prevent the location-based service from being properly executed. For example, database 204 may contain polygons representative of terrestrial geographical regions in which reception of GPS signals of adequate signal quality or number cannot be achieved, or cannot be achieved reliably. Communication pathway 203 is typically a parallel bus of electrical conductors, but any suitable means of transferring information from database 204 to computer system 202 may be used. Computer system 202 is further coupled to a second database 206 by means of a communication pathway 205. The information contained in database 206 is typically stored on one or more hard disk drives, but any suitable memory storage medium can be used. Database 206 may be flat, relational, or conform to any other database architecture. Database 206 as used in this illustrative embodiment of the present invention typically contains representations, such as but not limited to, polygon vertices, of geographical regions specified by a user or customer of the location-based service. Communication pathway 205 is typically a parallel bus of electrical conductors, but any suitable means of transferring information from second database 206 to computer system 202 may be used. Furthermore, databases 204 and 206 may be stored on the same disk drive and access to those databases may be via the same communication pathway.

Still referring to FIG. 2, a network interface is shown coupled to computer system 202 by means of communication pathway 207. Network interface 208 may be any suitable means of providing information transfer, i.e., sending and receiving, for computer system 202. In an illustrative embodiment, network interface 208 is an Ethernet-based interface to a local area network. The local area network, through various know hubs, bridges, switches and routers, which make up communication cloud (sometimes referred to as a communications fabric) 210, provides access to sources of incoming information, and to destinations for outgoing information. Various other network interfaces, such as but not limited to telephone modems, cable modems, and the like, are well known in this field and not further described herein.

FIG. 2 also shows communications cloud 210 connected to a computer 212 executing software that provides graphical user interface (GUI) 214. In an illustrative embodiment of the present invention, a user may communicate with service center 200 through GUI 214 running on computer 212. One specific form of communication between the user and service center 200, is the specification of boundaries that define one or more geographical regions. Such geographical boundary information is typically stored in second database 206. The specification of boundaries may be achieved by receiving from the user's GUI the pixel coordinates that are necessary to specify the boundary drawn on a particular view of a map displayed to the user. The pixel coordinates can then be processed at the service center using knowledge of the map and the scale factor at which it was displayed. Such processing is typically implemented in software running on a computer at the service center.

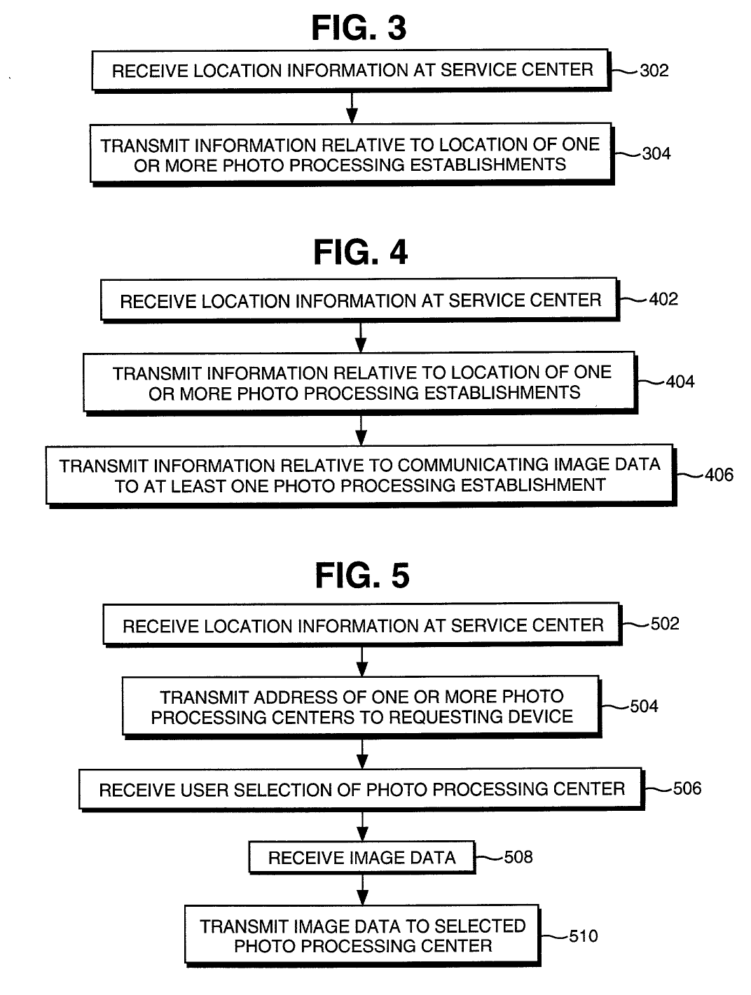

FIGS. 3-6 are flowcharts of various illustrative embodiments of the present invention from the perspective of a location-based service provider.

FIG. 3 is a flowchart of an illustrative process in accordance with the present invention that receives location information from a location-aware device relative to the position of the location-aware device, and transmits location information to the location-aware device relative to the position of one or more photo processing establishments. More particularly, location information, indicative of the location of a location-aware image capture device, is received by a location-based services provider 302. The location information may be received by the services provider directly by wireless transmission, or by a combination of wireless and wired transmission. In order to properly provide service to a large number of client devices, the services provider typically requires that in addition to location information, some type of client identification information also be transmitted to the services provider. This identification information is typically included in the same message. In response to the receipt of the location information from the location-aware image capture device, the services provider transmits 304 a message that contains information regarding the location of photo processing establishments within a region generally centered about the position of the location-aware image capture device. The size of the region may be selected based, at least in part, on a pre-determined and fixed radius, or may be based, at least in part, on the number of photo processing establishments found (e.g., keep expanding the region until a pre-determined number of photo processing establishments are found), or based, at least in part, on the number of photo processing establishments that meet certain criteria (e.g., one hour service, or a preferred manufacturer's paper). The message may be sent wirelessly, or by a combination of wired and wireless such as for example, via Internet to a cellular telephone system base station, and then transmitted wirelessly the location-aware image capture device. The information concerning the one or more photo processing establishments may be in any suitable format including, but not limited to, text, graphics, audio, video, or any combination thereof. In one embodiment, the data sent to the location-aware image capture device includes map data, i.e., information that can be displayed as a map. Typically, such map data includes markings indicating the location of the one or more photo processing establishments. Such markings may appear on the map in any suitable way such as, but not limited to, colored highlights, shading, arrows, pointers, underlines, flashing graphics, and variously shaped stipple patterns.

FIG. 4 is a flowchart of an illustrative process, in accordance with the present invention, that receives location information from a location-aware device relative to the position of the location-aware device, transmits location information to the location-aware device relative to the position of one or more photo processing establishments, and further transmits information to the location-aware device regarding communication of image data to at least one photo processing establishment. The embodiment shown in FIG. 4 is similar to that shown in FIG. 3, with the addition of transmitting information from the service center regarding how to directly communicate (e.g., telephone number of modem, email address, radio frequency and protocol, and so on) with the photo processing center. Referring to FIG. 4, location information is received by the location-based services provider 402. The location-based services provider transmits 404 information regarding the location of one or more photo processing establishments, as described above in connection with FIG. 3. The location-based services provider transmits 406 information regarding how to communicate image data from a specific location-aware image capture device to the one or more photo processing establishments. Together, the transmissions 404, 406, provide such data as can be used by the location-aware image capture device, either under software program control, or with input from a user, to decide which photo processing establishment to send image data to, and what communications format and addresses are needed to send image data to the selected photo processing center.

FIG. 5 is a flowchart of an illustrative process, in accordance with the present invention, that receives 502 location information from a location-aware image capture device relative to the position of the location-aware image capture device, transmits 504 location information relative to the position of one or more photo processing establishments (the transmission being intended to reach the location-aware device), receives 506 information from the location-aware device relative to the selection of one or more photo processing establishments, receives 508 image data from the location-aware product, and transmits 510 image data to the one or more selected photo processing establishments. More particularly, the process of FIG. 5, is performed by a location-based services provider, typically at a service center in which one or more computers are available to execute software, and various Input/Output (I/O) and communications circuits are available to process electrical and/or optical signals, for performing the process. Implementation and/or integration of the various hardware and software components of the present invention, as described herein with text and drawings, is within the ordinary skill level of those who practice in the field of computer and communications systems integration. The location information received at 502 typically includes identification information such that a determination can be made that the communication is received from an authorized customer, and/or how to communicate information back to the requesting device. The transmission at 504 can provide location information in any particular format, for example latitude and longitude; or a text-based message with city and street addresses; or a graphics-based message in the form of a map marked graphically with the location of the one or more photo processing establishments; or a series of maps marked with the location of one photo processing establishment each; or an audio and or video message describing the location of, and/or route to, one or more photo processing establishments; or any combination of the foregoing. The selection information received at 506, can be in any suitable format, for example a number, in digital form, can be received that corresponds to the selected photo processing establishment wherein the number 1 corresponds to the first location, the number 2 corresponds to the second location, and so on. Those skilled in the art of software development, and having the benefit of this disclosure, will recognize that there are many acceptable ways to format this information. The image data received at 508 may be in any suitable format, including but not limited to GIF, JPEG, MPEG, or any other standard or customized coding format. Typically, the service center will know the format of the image data prior to its reception by way of the customer identification information it has received. Such customer identification information may include a specification of the image data format to be used, or the image data format may be looked up in a database of attributes associated with the customer identification information. The transmission of information at 510 can be accomplished by any suitable means of communication whether wired or wireless, packet-switched or circuit switched, private network or public network. In a typical embodiment, the image data will be transmitted to the selected photo processing establishment via the Internet.

FIG. 6 is a flowchart of an illustrative process, in accordance with the present invention, that that receives location information from a location-aware device relative to the position of the location-aware device, transmits location information to the location-aware device relative to the position of one or more photo processing establishments, receives information from the location-aware device relative to the selection of one or more photo processing establishments, receives additional instructions from the location-aware device, receives image data from the location-aware product, and further transmits image data to the one or more selected photo processing establishments. FIG. 6 shows an alternative embodiment of the process shown and described in connection with FIG. 5, wherein additional information is received by the location-based services provider, and the services provider in turn takes additional actions based on the additional information. Location information is received at the service center of a location-based services provider 602. In this case the location information is received from a location-aware image capture device. The service provider sends back to the requesting device, e.g. a location-aware image capture device, the address of one or more photo processing establishments 604. As described above, the format of this address data may be any that is convenient, and suitable for reception and/or display at the location-aware image capture device. The service center receives 606 a selection from the requesting device a subset, or the whole set, of the one or more of the photo processing establishments that were transmitted at 604. The service center further receives instructions 608 from the requesting device. More particularly, the location-based services provider receives instructions in connection with making multiple prints of particular ones of various image data files, or receives instructions in connection with sending one or more image files to more than one photo processing establishment. In one example, the location-services provider receives instructions to forward, image data files 1 through 3 to a first photo processing establishment, where image data files 1 and 2 are to be printed twice and image data file 3 is to be printed five times; and image data files 4 through 7 are to be forwarded to a second photo processing establishment, which is at a different location than the first photo processing establishment, where the image data files are each to be printed six times. The foregoing, as noted, is simply an example of the instructions that can accompany the image data files. By way of example and not limitation, instructions can be included that specify the type of paper, or other substrate, on which the images are to be printed, the size, or scale factor of the images to be printed, color enhancement or changes (e.g., print in black and white rather than color), and so on. In this alternative embodiment, the location-based services provider receives one or more image data files along with instructions on where to send the one or more image data files and how the one or more image data files are to be processed. Image data is received at the service center 610. In accordance with the instructions that were received at 608, the service center sends the image data 612 to the one or more selected photo processing establishments along with any needed instructions as to how the image data is to be processed.

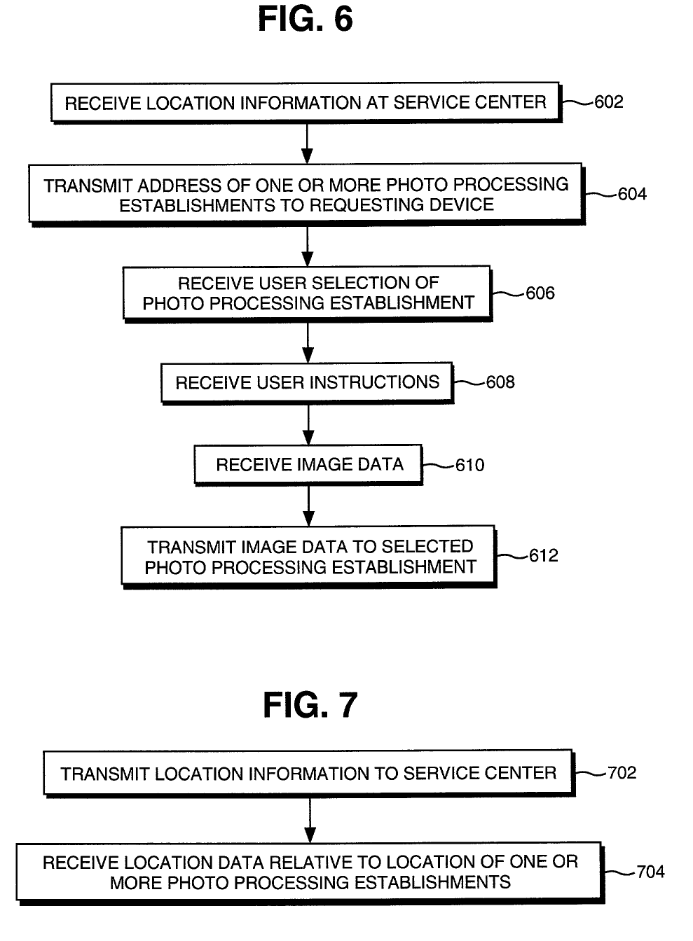

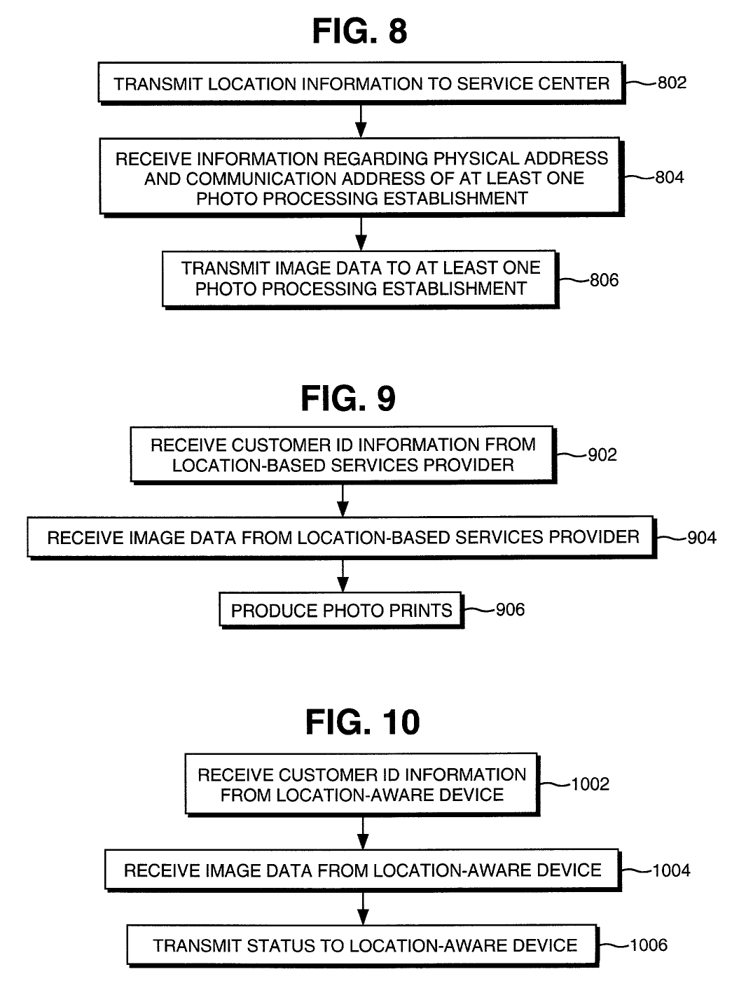

FIGS. 7-8 are flowcharts of illustrative embodiments of the present invention from the perspective of a location-aware image capture device.

FIG. 7 is a flowchart of an illustrative process, in accordance with the present invention, that transmits location information from a location-aware device to a location-based services provider, and receives location data relative to the location of one or more photo processing establishments. More particularly, the location-aware image capture device, such as, but not limited to a digital camera equipped with a GPS module and a cellular telephone, or operable to be communicatively coupled to a cellular telephone, transmits its location information, typically in latitude/longitude format and with an accuracy within approximately 100 meters, or better, of its true position, the transmission intended to be received a location-services provider 702. The location-aware image capture device also typically transmits identification information to the services provider. The identification information can be used by the services provider to look up the customer's preferences and/or the attributes of the location-aware image capture device with which it will communicate. By way of example, and not limitation, the service center may determine from a database lookup operation that this particular image capture device is capable of displaying high resolution map data rather than just text strings, and therefore can provide data that will be displayed as one or more maps on a display output of the image capture device. In a further example, a user of a location-aware image capture device may subscribe to one or more services from a location-based services provider, and furthermore may enter his or her preferences into a database by using, for example, a web-based tool. Such a web-based tool is a specific example of the general class of graphical user interfaces which run on computers. It will be understood that web-based, or other graphical user interfaces through which the user can submit preferences to the location-based services provider, can also be executed by the computational resources found within the location-aware image capture device itself. In such an example, the user can enter preferences such as, using only photo processing establishments that offer “one-hour” service, or that use only Kodak brand paper for producing prints of image data. At 704 the image capture device receives location information relative to the location of one or more photo processing establishments. As described above, this location information may be provided in any suitable format. The user of the location-aware image capture device then typically interacts with the image capture device to effect the communication of selections, instructions, and/or image data to one or more destinations.

FIG. 8 is a flowchart of an illustrative process, in accordance with the present invention, that is similar to the process shown in FIG. 7, but includes an additional operation of transmitting image data to one or more photo processing establishments. More particularly, location information is transmitted 802 from a location-aware device to a location-based services provider. In response to the transmission at 802, information regarding a physical and/or communication address of at least one photo processing establishment is received 804. Image data is then transmitted to at least one photo processing establishment 806. It will be appreciated that instructions may also be sent to the one or more photo processing establishments in order to specify the processing of the image data (e.g., number of copies, type of paper, billing information, etc.).

FIGS. 9-10 are flowcharts of illustrative embodiments of the present invention from the perspective of a photo processing establishment.

FIG. 9 is a flowchart of an illustrative process, in accordance with the present invention, that receives image data from a location-based services provider, receives customer identification information from a location-based services provider, and produces one or more photo prints. More particularly, a photo processing establishment receives customer identification information 902. The customer identification information may be received from a location-aware image capture device or from a location-based services provider. The customer identification information may be received via any suitable communications medium such as, but not limited to, wireless telephony, a combination of wired and wireless telephony, circuit-switched communication channels, packet-switched communication channels, the Internet, private radio networks, and so on. The customer identification information is used by the photo processing establishment to match up the hardcopy images produced by the establishment with the customer, or customer agent, that arrives at the establishment to pick up the hardcopy images. Similarly, depending on the instructions received, the photo processing establishment may ship the hardcopy to the customer at an address determined, at least in part, from the customer identification information. In this context, shipping includes any form of physical delivery, such as, but not limited to, private delivery service, government postal service, or any other suitable means. In one embodiment, the customer identification information also includes the information necessary to bill the charges for services rendered by the photo processing establishment to an entity other than the customer, such as, but not limited to, a location-based services provider, or a credit card account. The photo processing establishment may then bill for the services rendered. The photo processing establishment also receives image data 904. In this illustrative embodiment, the image data is received from a location-based services provider. The image data may be in any suitable format as described in detail hereinabove. The photo processing establishment then produces the desired hardcopy 906. Methods and apparatus for producing such high quality images, once the image data is received are well known in the art and are not described in greater detail herein.

FIG. 10 is a flowchart of an illustrative process, in accordance with the present invention, that receives customer identification information from the location-aware image capture device 1002, receives image data from a location-aware image capture device 1004, produces one or more photo prints 1006, and transmits status to the location-aware product 1008. More particularly, the status communications from the photo processing establishment to the location-aware image capture device include information regarding for example, the amount of time until the hardcopy or hardcopies will be ready, what the charges for the service will be, any problems processing the image data or providing the service, and so on.

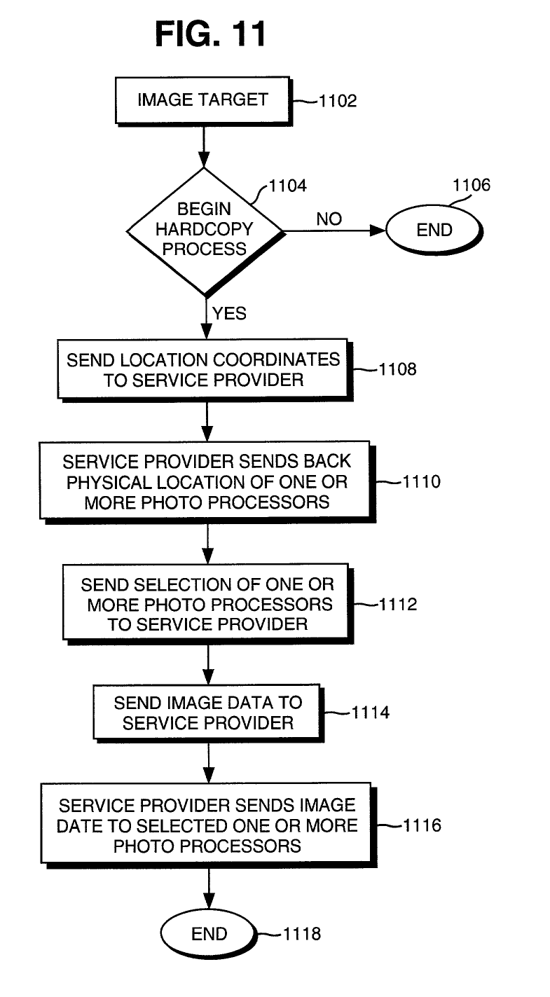

FIG. 11 is a flowchart of an exemplary process, showing various aspects of an embodiment of the present invention. More particularly, a location-aware image capture device images a target, thereby capturing image data representative of that target 1102. In one embodiment, this is accomplished by a location-aware digital camera that takes a picture of a scene desired by the user of the camera. A decision is then made 1104 as to whether to begin the hardcopy process. If the decision is “no”, then the process ends at 1106. If the decision is “yes”, then the location coordinates, i.e., data representative of the position of the camera to within some pre-determined tolerance, are sent to a location-based services provider 1108. In response to receipt of the location information, the location-based services provider sends information, relative to the location of one or more photo processing establishments, to the location-aware image capture device 1110. The information on the location of the photo processors is typically displayed on a display, such as, for example, a liquid crystal display (LCD), which forms a part of the location-aware image capture device. In some embodiments, additional information about the photo processing establishments In this way, the location, and in some embodiments, the attributes, of various ones of the photo processors are made available to a user of the location-aware image capture device. Attributes include, but are not limited to, items such as the hours of operation of the photo processing establishment, the types of paper or other recording media available on which to print, the typical completion time for printing, and so on. These attributes are collected by the location-based services provider and stored in a database along with the locations of the photo processors. The user, based at least in part on the displayed information, makes a selection as to which one or ones of the photo processors shall be selected for at least the purpose of receiving image data and producing hardcopies. After making a selection, the user indicates to the location-aware image capture device, typically by pressing one or more buttons on the device, that the selection information is to be transmitted to the location-based service provider 1112. The location-aware image capture device then transmits one or image data files to the location-based services provider 1114. The location-based services provider then sends the image data files to one or more selected photo processors, in accordance with the selection information 1116. The process then terminates at 1118.

The attributes stored in the database may be updated at fixed time intervals, or updated in real-time. An example of real-time attribute updating includes one or more photo processing establishments communicating turnaround time to the location-based services provider. In this way as the real-time workload and backlog of the photo processing establishments change, this information, reflective of how quickly a new job can be completed, can be made available to users to assist in their decision making about where to send their image data for processing and/or printing.

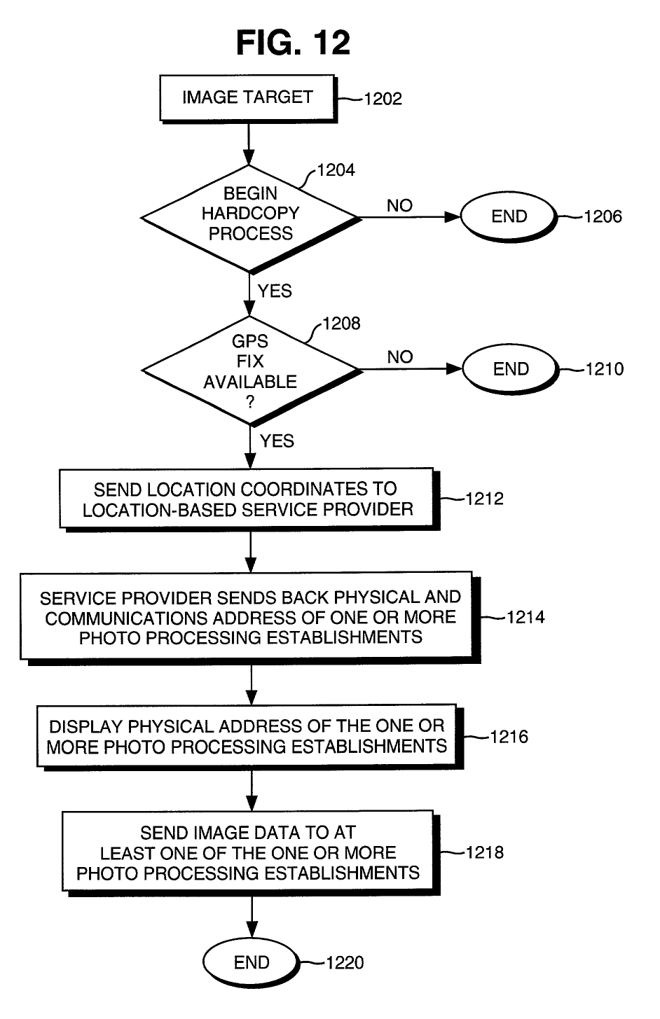

FIG. 12 is a flowchart of another exemplary process, showing various aspects of embodiments of the present invention. More particularly, a location-aware image capture device images a target, thereby capturing image data representative of that target 1202. In one embodiment, this is accomplished by a location-aware digital camera that takes a picture of a scene desired by the user of the camera. A decision is then made 1204 as to whether to begin the hardcopy process (i.e., to begin the process of getting hardcopies, or printouts, of the image data made). If the decision is “no”, then the process ends at 1206. If the decision is “yes”, then a decision is made 1208 as to whether it is possible to get a GPS fix, i.e., are there enough GPS signals of adequate signal quality for a GPS module to determine its location. If the decision is “no”, then the process ends at 1210. If the decision is “yes”, then the location coordinates, i.e., data representative of the position of the camera to within some pre-determined tolerance, are sent to a location-based services provider 1212. The location-based services provider, in response to receipt of the location, transmits to the location-aware image capture device, information relative to the physical address, communications, address, and optionally the attributes of one or more photo processors 1214. The location-aware image capture device then displays at least a portion of this information for the user 1216. Based on inputs from the user, the location-aware image capture device transmits one or more image data files to one or more photo processing establishments 1218. The process then terminates at 1220.

Conclusion

Embodiments of the present invention allow an image capture device that is integrated with, or operatively coupled to, a location information resource so as to provide location awareness, to receive information regarding photo processing establishments in a region typically centered about the location of the image capture device. The received information typically includes the location of the photo processing establishments, usually in the form of text-based addresses and/or map display data. The received information may also include information relative to how to electronically communicate with the photo processing establishments. The received information may also include various attributes of the photo processing establishments including but not limited to hours of operation, type of services and products available, turnaround time, and so on.

The present invention may be implemented as circuit-based solutions, including possible implementation on a single integrated circuit. As would be apparent to one skilled in the art, various functions of circuit elements may also be implemented as processing operations in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as punched cards, magnetic tape, floppy disks, hard disk drives, CD-ROMs, flash memory cards, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It is to be understood that the present invention is not limited to the embodiments described above, but encompasses any and all embodiments within the scope of the following claims.

What is claimed is:

1. A method of providing a location-based service, comprising:
receiving first location information, the first location information representative of a position of an image capture device; and
transmitting second location information to the image capture device, the second location information representative of the location of one or more photo processing establishments.

2. The method of claim 1, wherein the image capture device is a location-aware digital camera.

3. The method of claim 1, wherein the image capture device is a camera that is communicably, and removably attached to a location-aware device.

4. The method of claim 1, further comprising transmitting information from the location-based service provider to the image capture device, the information describing how to wirelessly communicate with the at least one photo processing establishments.

5. The method of claim 1, further comprising receiving from the image capture device, a user selection indicating at least one of the one or more photo processing establishments with which the service center is to subsequently communicate.

6. The method of claim 5, further comprising receiving image data from the image capture device.

7. The method of claim 6, further comprising transmitting the image data to the at least one selected photo processing centers.

8. The method of claim 1, wherein the second location information is selected from a database of photo processing establishments, and the selection is based, at least in part, on a user's pre-defined preferences.

9. The method of claim 8, wherein the user's pre-defined preferences are established with the location-based services provider via a graphical user interface running on a computer.

10. The method of claim 8, wherein the user's pre-defined preferences are established with the location-based services provider via a graphical user interface running on the image capture device.

11. The method of claim 1, further comprising transmitting attribute information, the attribute information being associated with the one or more photo processing establishments.

12. The method of claim 1, further comprising generating the second location information based, at least in part, on a user's preferences.

13. A method of providing a location-based service, comprising:
transmitting first location information from an image capture device to a location-based services processing center; and
receiving second location information relative to the location of one or more photo processing establishments.

14. The method of claim 13, wherein the second location information comprises geographical coordinates of one or more photo processing establishments.

15. The method of claim 13, wherein the second location information comprises a message in a format selected from the group consisting of text, graphics, audio, and video.

16. The method of claim 13, wherein the second location information comprises one or more data files that, when displayed, appear as maps with the location of one or more photo processing establishments marked thereon.

16. The method of claim 13, further comprising transmitting one or more image data files to a location-based services provider.

17. The method of claim 13, further comprising transmitting one or more image data files to at least one of the one or more photo processing establishments.

18. A method of providing hardcopy of image data, comprising:
receiving, at a photo processing establishment, customer identification information from a location-based services provider;
receiving, at a photo processing establishment, image data from a location-based services provider; and
printing the image data.

19. The method claim 18, further comprising billing the charges associated with printing the image data to the location-based services provider.

20. The method of claim 18, further comprising billing the charges associated with printing the image data to the a credit card account.

21. The method of claim 18, further comprising shipping the printed image data to a pre-determined addressed.

22. The method of claim 18, further comprising:
receiving, at the photo processing establishment, instructions regarding the processing of the image data; and
billing the charges associated with printing the image data to a credit card account.

23. The method of claim 18, further comprising:
receiving, at the photo processing establishment, instructions regarding the processing of the image data; and
billing the charges associated with printing the image data to the location-based services provider.

24. A method of providing hardcopy of image data, comprising:
receiving, at a photo processing establishment, customer identification information from a location-aware image capture device;
receiving, at the photo processing establishment, image data from the location-aware image capture device; and
printing the image data.

25. The method of claim 24, wherein the customer identification information comprises information identifying a location-based services provider; and further comprising billing the charges associated with printing the image data to the location-based services provider.

26. The method of claim 24, further comprising transmitting status updates to the location-aware image capture device.
